(19) United States
(12) Patent Application Publication
(10) Pub. No.: US 2026/0193925 A1
(43) Pub. Date: Jul. 9, 2026

(54) DOOR OPENING AND CLOSING DEVICE

(71) Applicant: AISIN CORPORATION, Kariya (JP)

(72) Inventor: Seiichi SUMIYA, Kariya-shi (JP)

(73) Assignee: AISIN CORPORATION, Kariya (JP)

(21) Appl. No.: 19/437,708

(22) Filed: Dec. 31, 2025

(30) Foreign Application Priority Data
Jan. 8, 2025 (JP) 2025-003062

(51) Int. Cl. E05F 15/627; E05F 15/605

(52) U.S. Cl. CPC E05F 15/627; E05F 15/605; E05Y 2900/546

(57) ABSTRACT

Provided is a door opening and closing device for opening and closing a vehicle door that opens and closes a door opening of a vehicle body, the vehicle door including a first door that rotates about a first door axis with respect to the vehicle body and a second door that rotates about a second door axis extending in the same direction as the first door axis with respect to the first door, the door opening and closing device including: a first rotating body configured to rotate together with the first door; a second rotating body configured to rotate together with the second door; and a transmission member wound around both the first rotating body and the second rotating body, and configured to transmit a torque from one rotating body of the first rotating body and the second rotating body to the other rotating body by being unwound from the other rotating body of the first rotating body and the second rotating body when being wound up around the one rotating body.

### CROSS REFERENCE TO RELATED APPLICATIONS

This application is based on and claims priority under 35 U.S.C. § 119 to Japanese Patent Application 2025-003062, filed on Jan. 8, 2025, the entire content of which is incorporated herein by reference.

### TECHNICAL FIELD

This disclosure relates to a door opening and closing device.

### BACKGROUND DISCUSSION

In the related art, a vehicle including a vehicle body that has a door opening, a back door that opens and closes the door opening, and a door opening and closing device that drives the back door is known. For example, a back door disclosed in JP 2022-88083A (Reference 1) includes an upper door that rotates about an axis extending in a width direction with respect to a vehicle body, and a lower door that rotates about an axis extending in the width direction with respect to the upper door. A door opening and closing device includes a drive unit that drives the upper door and a drive unit that drives the lower door. The door opening and closing device bends the lower door with respect to the upper door when operating the back door to open, that is, when operating the upper door to open. In this way, even when an obstacle is present behind the vehicle, the door opening and closing device prevents the back door from coming into contact with the obstacle.

Regarding the door opening and closing device as described above, there is room for improvement in terms of simplifying the structure of the device. A need thus exists for a door opening and closing device which is not susceptible to the drawback mentioned above

### SUMMARY

According to an aspect of this disclosure, there is provided a door opening and closing device for opening and closing a vehicle door that opens and closes a door opening of a vehicle body, the vehicle door including a first door that rotates about a first door axis with respect to the vehicle body and a second door that rotates about a second door axis extending in the same direction as the first door axis with respect to the first door, the door opening and closing device including: a first rotating body configured to rotate together with the first door; a second rotating body configured to rotate together with the second door; and a transmission member wound around both the first rotating body and the second rotating body, and configured to transmit a torque from one rotating body of the first rotating body and the second rotating body to the other rotating body by being unwound from the other rotating body of the first rotating body and the second rotating body when being wound up around the one rotating body.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a rear view illustrating a schematic configuration of a vehicle;

FIG. 2 is a side view illustrating a schematic configuration of the vehicle in FIG. 1;

FIG. 3 is a perspective view of a door opening and closing device of the vehicle in FIG. 1;

FIG. 4 is a perspective view of the door opening and closing device of the vehicle in FIG. 1;

FIG. 5 is an exploded perspective view of the door opening and closing device of the vehicle in FIG. 1;

FIG. 6 is an exploded perspective view of the door opening and closing device of the vehicle in FIG. 1;

FIG. 7 is an exploded perspective view of the door opening and closing device of the vehicle in FIG. 1;

FIG. 8 is a side view of a main part of the door opening and closing device of the vehicle in FIG. 1;

FIG. 9 is a rear view of the main part of the door opening and closing device of the vehicle in FIG. 1;

FIG. 10 is a schematic diagram illustrating operations of portions constituting a four-joint link mechanism of the door opening and closing device of the vehicle in FIG. 1;

FIG. 11 is a side view of a back door of the vehicle in FIG. 1 when the back door is located at a fully closed position;

FIG. 12 is a side view of the back door of the vehicle in FIG. 1 when the back door is located at a first intermediate position;

FIG. 13 is a side view of the back door of the vehicle in FIG. 1 when the back door is located at a second intermediate position;

FIG. 14 is a side view of the back door of the vehicle in FIG. 1 when the back door is located at a fully open position; and

FIG. 15 is a rear view illustrating a schematic configuration of the vehicle in FIG. 1.

### DETAILED DESCRIPTION

Hereinafter, an embodiment of a vehicle including a door opening and closing device will be described.

### Configuration of Embodiment

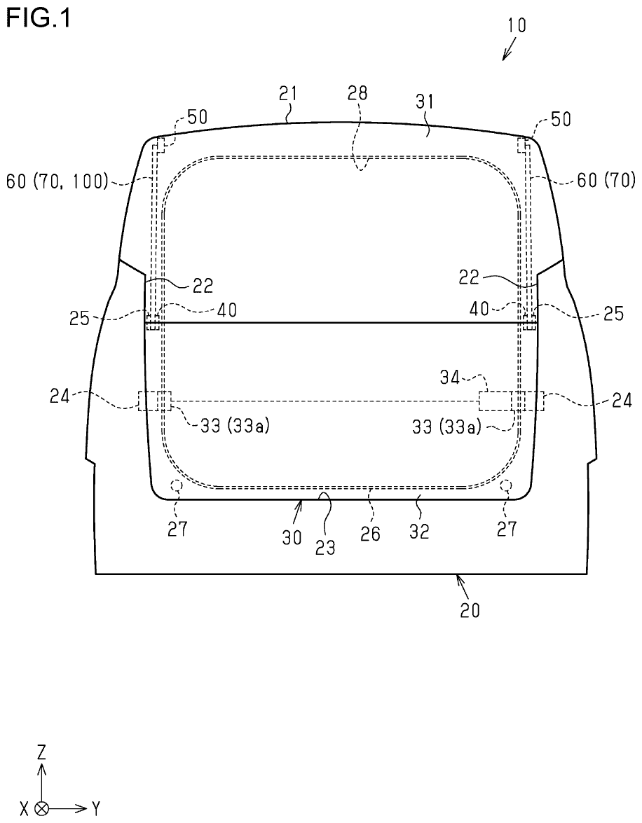

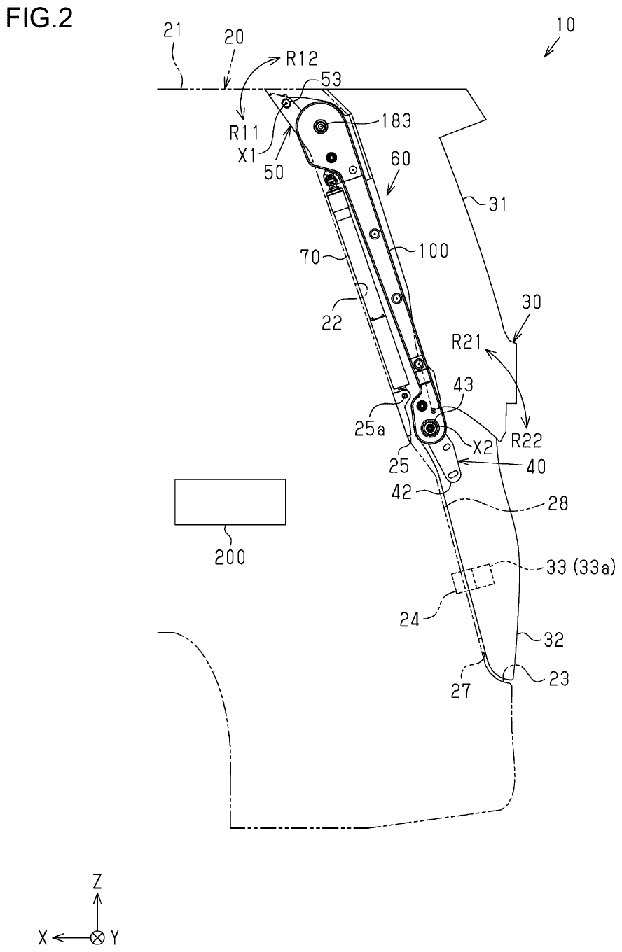

As illustrated in FIGS. 1 and 2, a vehicle 10 includes a vehicle body 20, a back door 30, two first hinges 50, a door opening and closing device 60, and a door control device 200. Hereinafter, a width direction of the vehicle 10 is referred to as a width direction, a front-rear direction of the vehicle 10 is referred to as a front-rear direction, and an up-down direction of the vehicle 10 is referred to as an up-down direction. In the width direction, a direction toward a center of the vehicle 10 is referred to as inward, and a direction away from the center of the vehicle 10 is referred to as outward. In the drawings, the front-rear direction is a direction in which an X axis extends, the width direction is a direction in which a Y axis extends, and the up-down direction is a direction in which a Z axis extends.

### Vehicle Body 20

The vehicle body 20 includes a roof 21, two rear pillars 22, a rear cross member 23, two strikers 24, two support brackets 25, a weather strip 26, and two stoppers 27. The vehicle body 20 has a door opening 28.

The roof 21, the two rear pillars 22 and the rear cross member 23 constitute a frame or a monocoque of the vehicle body 20. The roof 21 constitutes an upper portion of the vehicle body 20. The two rear pillars 22 and the rear cross member 23 are located at a rear portion of the vehicle body 20. The two rear pillars 22 extend in the up-down direction at an interval in the width direction. Specifically, as viewed from the rear of the vehicle 10, the two rear pillars 22 extend outward in the width direction while extending downward. The rear cross member 23 connects the two rear pillars 22 in the width direction. The rear cross member 23 is located below the roof 21.

The door opening 28 opens to the rear portion of the vehicle 10. As viewed from the rear, the door opening 28 has a rectangular shape. The door opening 28 is defined by the two rear pillars 22 in the width direction. The door opening 28 is defined by the roof 21 and the rear cross member 23 in the up-down direction.

The two strikers 24 are, for example, U-shaped. The two strikers 24 are fixed to the two rear pillars 22, respectively. The two strikers 24 protrude inward in the width direction from the two rear pillars 22, respectively. The two strikers 24 restrain the back door 30 when the back door 30 is located at a fully closed position where the door opening 28 is fully closed. The two support brackets 25 have ball studs 25a. The two support brackets 25 are fixed to the two rear pillars 22, respectively. At this time, the ball stud 25a protrudes inward in the width direction. The two support brackets 25 are located above the two strikers 24, respectively.

The weather strip 26 has a frame shape. The weather strip 26 is made of elastomer such as rubber or resin having appropriate elasticity. The weather strip 26 is disposed so as to surround the door opening 28. When the back door 30 is located at the fully closed position, the weather strip 26 is elastically compressed by the back door 30. In this way, the weather strip 26 prevents a liquid such as rainwater from entering a vehicle interior through a gap between the weather strip 26 and the back door 30. In another embodiment, the weather strip 26 may be fixed to the back door 30 instead of the vehicle body 20.

The two stoppers 27 are made of elastomer such as rubber or resin having appropriate elasticity. The two stoppers 27 are disposed near a lower end of the door opening 28 on the vehicle body 20. When the back door 30 is located at the fully closed position, the two stoppers 27 are elastically compressed between the vehicle body 20 and the back door 30. In this way, the two stoppers 27 restrict a posture of the back door 30. In another embodiment, the two stoppers 27 may be fixed to the back door 30 instead of the vehicle body 20. The number of stoppers 27 can be changed as appropriate. Further, a height of the stopper 27 is preferably adjustable.

### Back Door 30

As illustrated in FIGS. 1 and 2, the back door 30 has a size corresponding to the door opening 28. The back door 30 operates between the fully closed position where the door opening 28 is fully closed and a fully open position where the door opening 28 is fully opened. The back door 30 includes an upper door 31, a lower door 32, two door lock mechanisms 33, a door lock drive unit 34, and a second hinge 40. The back door 30 corresponds to a “vehicle door”, the upper door 31 corresponds to a “first door”, and the lower door 32 corresponds to a “second door”.

The upper door 31 has a size corresponding to an upper half of the door opening 28. The upper door 31 includes, for example, a back door glass. The lower door 32 has a size corresponding to a lower half of the door opening 28. The lower door 32 has a bag shape. The lower door 32 can accommodate a plurality of components of the back door 30. Hereinafter, as illustrated in FIG. 1, in a state where the back door 30 is located at the fully closed position, an upper end of the upper door 31 is referred to as a base end of the upper door 31, and a lower end of the upper door 31 is referred to as a tip end of the upper door 31. Further, an upper end of the lower door 32 is referred to as a base end of the lower door 32, and a lower end of the lower door 32 is referred to as a tip end of the lower door 32.

As illustrated in FIG. 1, the two door lock mechanisms 33 are paired in the width direction. The two door lock mechanisms 33 each include a latch 33a that is displaced between a full-latch position at which the latch 33a can be locked to the striker 24 and an unlatch position at which the latch 33a cannot be locked to the striker 24. The two door lock mechanisms 33 are respectively accommodated at both ends of the lower door 32 in the width direction. In the lower door 32, a notch for exposing the latch 33a is provided in a portion where the door lock mechanism 33 is provided.

The door lock drive unit 34 is an actuator using an electric motor as a drive source. The door lock drive unit 34 is accommodated in the lower door 32. In the embodiment, the door lock drive unit 34 is integrated with one of the two door lock mechanisms 33, and is connected to the other door lock mechanism 33 via a wire cable or the like. The door lock drive unit 34 drives the two door lock mechanisms 33 to displace the latch 33a to the unlatch position or displace the latch 33a to the full-latch position. Specifically, when the back door 30 performs a closing operation, the door lock drive unit 34 displaces the latch 33a to the full-latch position after the back door 30 moves to the vicinity of the fully closed position. In this way, the door lock drive unit 34 restrains the back door 30 to the vehicle body 20. On the other hand, when the back door 30 performs an opening operation, the door lock drive unit 34 displaces the latch 33a to the unlatch position. In this way, the door lock drive unit 34 releases the restraint of the back door 30 to the vehicle body 20. In another embodiment, the back door 30 may include two door lock drive units 34 that respectively drive the two door lock mechanisms 33.

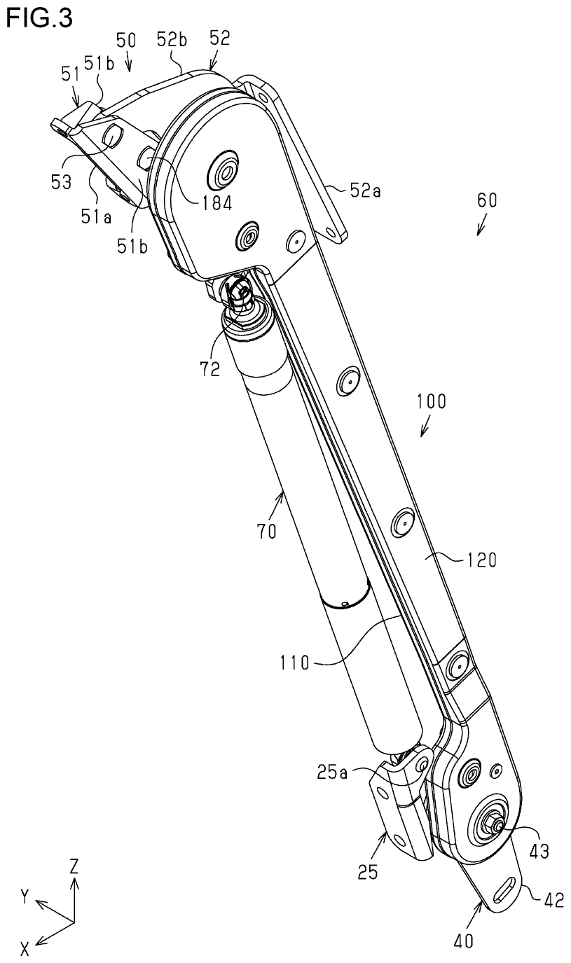

The two second hinges 40 are paired in the width direction in the back door 30. Therefore, hereinafter, one of the second hinges 40 will be described in detail. As illustrated in FIGS. 3, 4, and 7, the second hinge 40 includes an upper bracket 41, a lower bracket 42, and a second coupling shaft 43.

The upper bracket 41 and the lower bracket 42 have a plate shape. The upper bracket 41 is located near the tip end of the upper door 31 and is fixed to one side surface of the upper door 31 intersecting the width direction. Similarly, the lower bracket 42 is located near the base end of the lower door 32 and is fixed to one side surface of the lower door 32 intersecting the width direction. The second coupling shaft 43 has a columnar shape. The second coupling shaft 43 is inserted into the upper bracket 41 and the lower bracket 42. At this time, a portion having a circular cross section of the second coupling shaft 43 is inserted into a circular hole of the upper bracket 41, and a portion having a non-circular cross section of the second coupling shaft 43 is inserted into a non-circular hole of the lower bracket 42. In this way, the upper bracket 41 is rotatable with respect to the second coupling shaft 43. On the other hand, the lower bracket 42 is not rotatable with respect to the second coupling shaft 43. In other words, the lower bracket 42 is rotatable integrally with the second coupling shaft 43. In the embodiment, as viewed from an insertion direction of the second coupling shaft 43, a boundary between the lower bracket 42 and the second coupling shaft 43 has a D shape.

In this way, the two second hinges 40 couple the upper door 31 and the lower door 32 so as to be relatively rotatable. Although the number of the second hinges 40 is two in the embodiment, in another embodiment, the number of the second hinges 40 may be one or three or more. Hereinafter, an axis of the second coupling shaft 43, that is, a rotation axis of the upper door 31 and the lower door 32 is referred to as a “second door axis X2”. Rotation directions of the lower door 32 about the second door axis X2 with respect to the upper door 31 are referred to as “a first rotation direction R21 and a second rotation direction R22”.

### First Hinge 50

As illustrated in FIGS. 1 and 2, the two first hinges 50 are paired in the width direction. Therefore, hereinafter, one of the first hinges 50 will be described in detail. As illustrated in FIGS. 3 to 6, the first hinge 50 includes a vehicle body-side bracket 51, a door-side bracket 52, and a first coupling shaft 53.

The vehicle body-side bracket 51 includes a fixed wall 51a and two support walls 51b. The fixed wall 51a and the two support walls 51b have a plate shape. The two support walls 51b extend from the fixed wall 51a in a plate thickness direction of the fixed wall 51a with an interval therebetween. The fixed wall 51a is fixed to the rear pillar 22 of the vehicle body 20. The vehicle body-side brackets 51 are located above the support brackets 25, respectively. At this time, a plate thickness direction of the two support walls 51b is the width direction. The vehicle body-side bracket 51 can also be referred to as a component of the vehicle body 20 since the vehicle body-side bracket 51 is fixed to the vehicle body 20.

The door-side bracket 52 includes a fixed wall 52a, a support wall 52b, and a ball stud 52c. The fixed wall 52a and the support wall 52b have a plate shape. The support wall 52b extends from the fixed wall 52a in a plate thickness direction of the fixed wall 52a. The ball stud 52c protrudes from the support wall 52b in a plate thickness direction of the support wall 52b. The fixed wall 52a is fixed near the upper end of the upper door 31. At this time, the plate thickness direction of the support wall 52b is the width direction. The door-side bracket 52 can also be referred to as a component of the upper door 31 since the door-side bracket 52 is fixed to the upper door 31.

The first coupling shaft 53 has a columnar shape. The first coupling shaft 53 couples the vehicle body-side bracket 51 and the door-side bracket 52 so as to be relatively rotatable. At this time, the support wall 52b of the door-side bracket 52 is located between the two support walls 51b of the vehicle body-side bracket 51.

In this way, the two first hinges 50 rotatably couple the upper door 31 to the vehicle body 20. Although the number of the first hinges 50 is two in the embodiment, in another embodiment, the number of the first hinges 50 may be one or three or more. In the following description, an axis of the first coupling shaft 53, that is, a rotation axis of the vehicle body 20 and the upper door 31 is referred to as a “first door axis X1”. Rotation directions of the upper door 31 about the first door axis X1 with respect to the vehicle body 20 is referred to as “a first rotation direction R11 and a second rotation direction R12”.

### Door Opening and Closing Device 60

As illustrated in FIGS. 1 and 2, the door opening and closing device 60 includes two door drive units 70 and a power transmission mechanism 100. In the embodiment, the door drive units 70 are respectively disposed on both sides of the door opening 28 in the width direction, while the power transmission mechanism 100 is disposed only on one side of the door opening 28 in the width direction. In another embodiment, the door drive unit 70 may be disposed only on one side of the door opening 28 in the width direction. Further, the power transmission mechanism 100 may be disposed on both sides of the door opening 28 in the width direction.

### Door Drive Unit 70

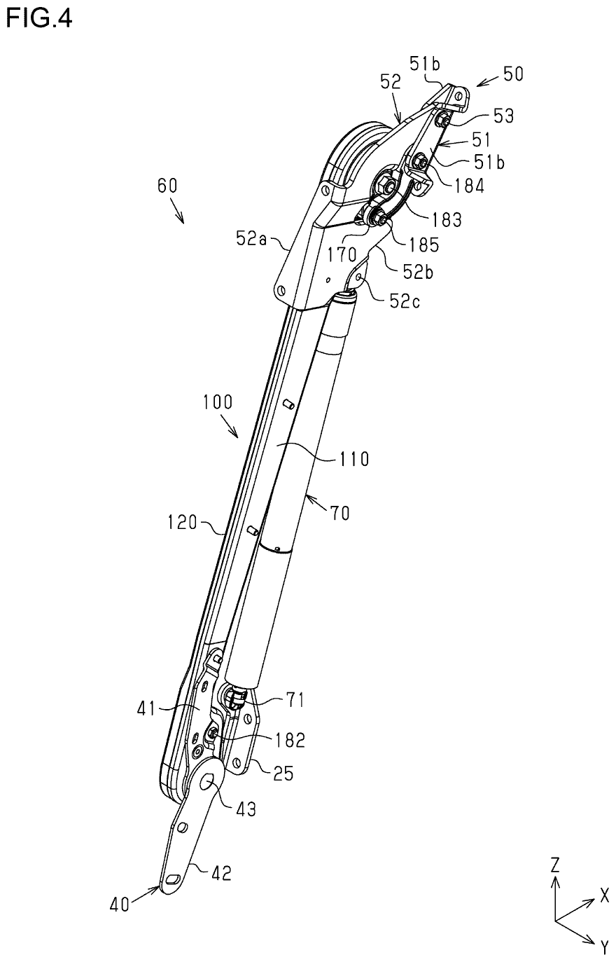

As illustrated in FIGS. 1 and 2, the two door drive units 70 are paired in the width direction. Therefore, hereinafter, one door drive unit 70 will be described in detail. As illustrated in FIGS. 3 and 4, the door drive unit 70 has a rod shape. The door drive unit 70 is an electric actuator that extends and contracts in an axial direction. As an example, the door drive unit 70 may be a linear motion actuator including an electric motor and a feed screw mechanism. The door drive unit 70 includes two ball sockets 71 and 72. The two ball sockets 71 and 72 constitute both end portions of the door drive unit 70 in the axial direction.

As illustrated in FIG. 3, the ball stud 25a of the support bracket 25 is inserted into the ball socket 71 of the door drive unit 70 on one side of the door opening 28 in the width direction. In this way, the ball socket 71 of the door drive unit 70 and the ball stud 25a of the support bracket 25 constitute a ball joint. As illustrated in FIG. 4, the ball stud 52c of the door-side bracket 52 is inserted into the ball socket 72 of the door drive unit 70 on one side of the door opening 28 in the width direction. In this way, the ball socket 72 of the door drive unit 70 and the ball stud 52c of the door-side bracket 52 constitute a ball joint.

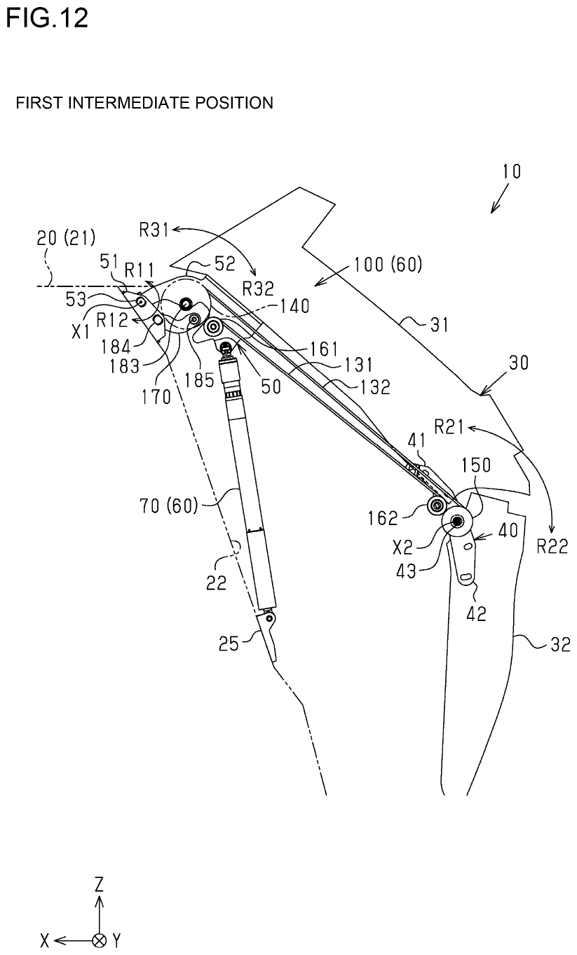

As illustrated in FIG. 12, when the door drive unit 70 extends, a torque around the first door axis X1 in the first rotation direction R11 acts on the upper door 31. That is, when the door drive unit 70 extends, the upper door 31 rotates in the first rotation direction R11 with respect to the vehicle body 20. On the other hand, when the door drive unit 70 contracts regardless of the position of the back door 30, a torque around the first door axis X1 in the second rotation direction R12 acts on the upper door 31. That is, when the door drive unit 70 contracts, the upper door 31 rotates in the second rotation direction R12 with respect to the vehicle body 20. The first rotation direction R11 corresponds to an opening direction of the upper door 31, and the second rotation direction R12 corresponds to a closing direction of the upper door 31.

### Power Transmission Mechanism 100

As illustrated in FIGS. 3 to 7, the power transmission mechanism 100 includes a base 110, a cover 120, two cables 131 and 132, two pulleys 140 and 150, two intermediate pulleys 161 and 162, and a transmission link 170. The power transmission mechanism 100 includes a plurality of pulley support shafts 181 and 182 and a plurality of link support shafts 183 to 185.

The base 110 is an elongated member. The base 110 is formed by, for example, pressing a metal plate. The cover 120 is an elongated member. The cover 120 may be formed, for example, by pressing a metal plate or by injection molding a resin material. The cover 120 has the same shape as the base 110. The cover 120 is configured to cover components of the door opening and closing device 60 together with the base 110. In other words, the cover 120 constitutes a housing together with the base 110.

The opening cable 131 and the closing cable 132 are metal wires having appropriate elasticity. The opening cable 131 and the closing cable 132 are separate cables. The opening cable 131 and the closing cable 132 preferably have a structure for fixing at both end portions. The opening cable 131 and the closing cable 132 correspond to a “transmission member”.

The first pulley 140 includes a pulley body 141 and a coupling member 142.

A first end of the opening cable 131 and a first end of the closing cable 132 are fixed to the pulley body 141. When the pulley body 141 rotates in a first rotation direction R31, the pulley body 141 winds up the closing cable 132 and unwinds the opening cable 131. On the other hand, when the pulley body 141 rotates in a second rotation direction R32, the pulley body 141 winds up the opening cable 131 and unwinds the closing cable 132. In this respect, the opening cable 131 and the closing cable 132 are wound around the pulley body 141. The pulley body 141 includes an engagement shaft 141a protruding in an axial direction of the pulley body 141. The engagement shaft 141a has an annular shape. An inner peripheral surface of the engagement shaft 141a has a non-circular shape as viewed from the axial direction. The first pulley 140 corresponds to a “first rotating body”.

The coupling member 142 includes an annular portion 142a and a coupling portion 142b. The annular portion 142a has an annular shape. The coupling portion 142b is a portion to which the transmission link 170 is coupled. When the coupling member 142 is viewed from an axial direction, the coupling portion 142b is located to be shifted from a central axis of the annular portion 142a. The engagement shaft 141a of the pulley body 141 is inserted into the annular portion 142a of the coupling member 142. At this time, the portion having a non-circular cross section of the engagement shaft 141a of the pulley body 141 is inserted into a non-circular hole of the annular portion 142a of the coupling member 142. In this way, the coupling member 142 is not rotatable with respect to the pulley body 141. In other words, the coupling member 142 is rotatable integrally with the pulley body 141. In the embodiment, as viewed from an insertion direction of the engagement shaft 141a of the pulley body 141, a boundary between the coupling member 142 and the engagement shaft 141a of the pulley body 141 has a serrated shape. In another embodiment, the coupling member 142 and the pulley body 141 may be integrated using, for example, a key groove and a key. When the first pulley 140 is formed by resin molding, the coupling member 142 and the pulley body 141 may be integrally molded.

An outer diameter of the second pulley 150 is smaller than an outer diameter of the pulley body 141 of the first pulley 140. Here, the outer diameter of the pulley is an outer diameter of a portion of the pulley around which the cable is wound. A second end of the opening cable 131 and a second end of the closing cable 132 are fixed to the second pulley 150. In the embodiment, the second pulley 150 is a driven pulley. When the first pulley 140 winds up the closing cable 132, the second pulley 150 rotates in the first rotation direction R21 and winds up the opening cable 131 unwound from the first pulley 140. On the other hand, when the first pulley 140 winds up the opening cable 131, the second pulley 150 rotates in the second rotation direction R22 and winds up the closing cable 132 unwound from the first pulley 140. In this respect, it can be said that the opening cable 131 and the closing cable 132 are wound around the second pulley 150. The second pulley 150 corresponds to a “second rotating body”.

The first intermediate pulley 161 and the second intermediate pulley 162 are smaller than the first pulley 140 and the second pulley 150. In this respect, an outer diameter of the first intermediate pulley 161 is smaller than outer diameters of both the first pulley 140 and the second pulley 150, and an outer diameter of the second intermediate pulley 162 is smaller than the outer diameters of both the first pulley 140 and the second pulley 150. On the other hand, a groove width of the first intermediate pulley 161 is preferably wider than groove widths of both the first pulley 140 and the second pulley 150, and a groove width of the second intermediate pulley 162 is preferably wider than the groove widths of both the first pulley 140 and the second pulley 150. The opening cable 131 is wound around the first intermediate pulley 161 near the first pulley 140. The opening cable 131 is wound around the second intermediate pulley 162 near the second pulley 150. The first intermediate pulley 161 and the second intermediate pulley 162 correspond to an “intermediate rotating body”.

Rotation axes of the first pulley 140, the second pulley 150, the first intermediate pulley 161, and the second intermediate pulley 162 all extend in the width direction. That is, the rotation axes of these pulleys are parallel to the first door axis X1 and parallel to the second door axis X2.

The transmission link 170 has an elongated plate shape. The transmission link 170 is slightly curved with respect to a longitudinal direction thereof. The transmission link 170 is preferably made of a highly rigid material such as metal. The transmission link 170 corresponds to a “transmission body”.

### Engagement Relationship of Door Opening and Closing Device 60

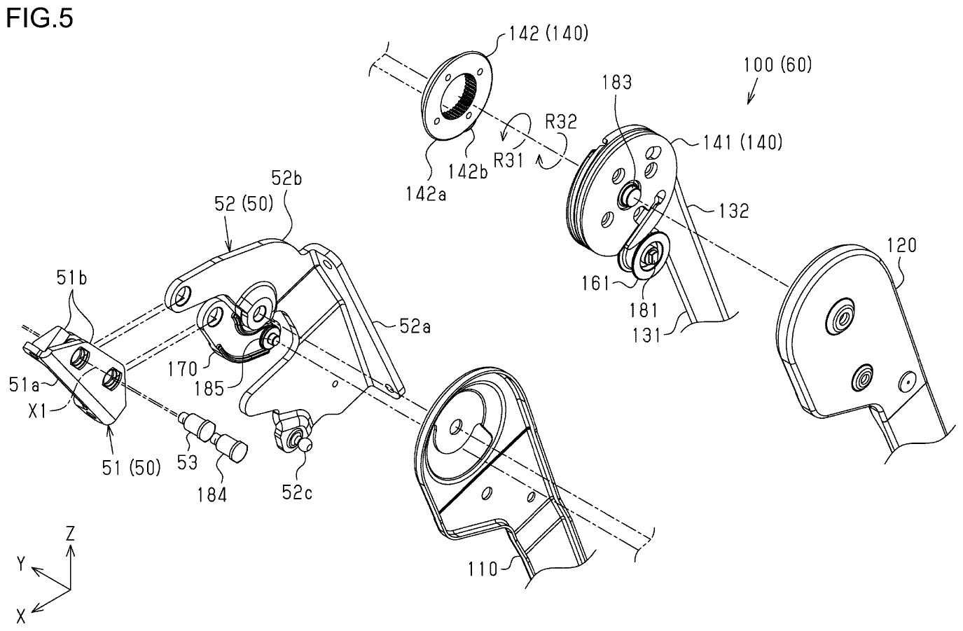

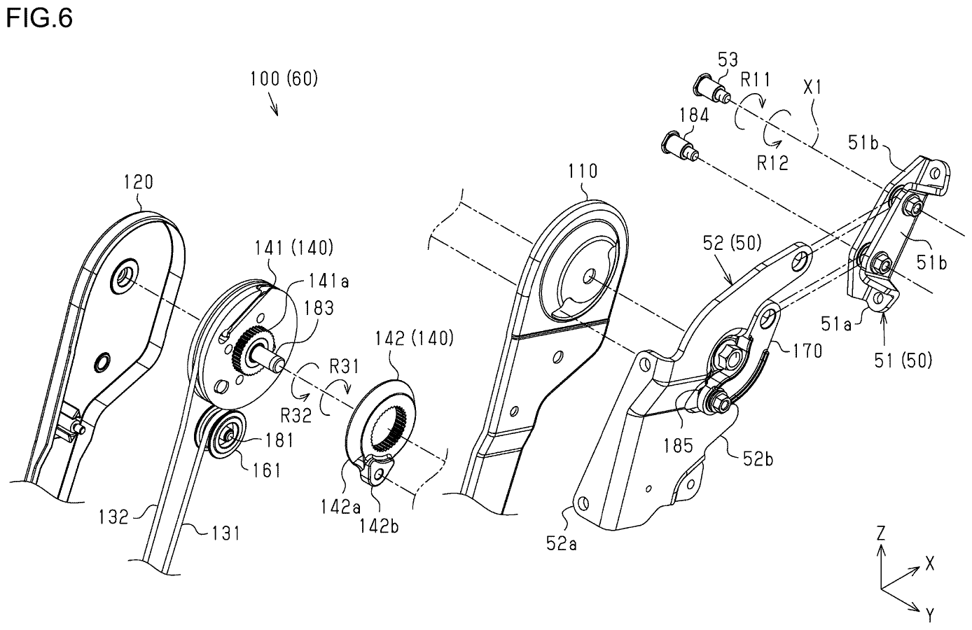

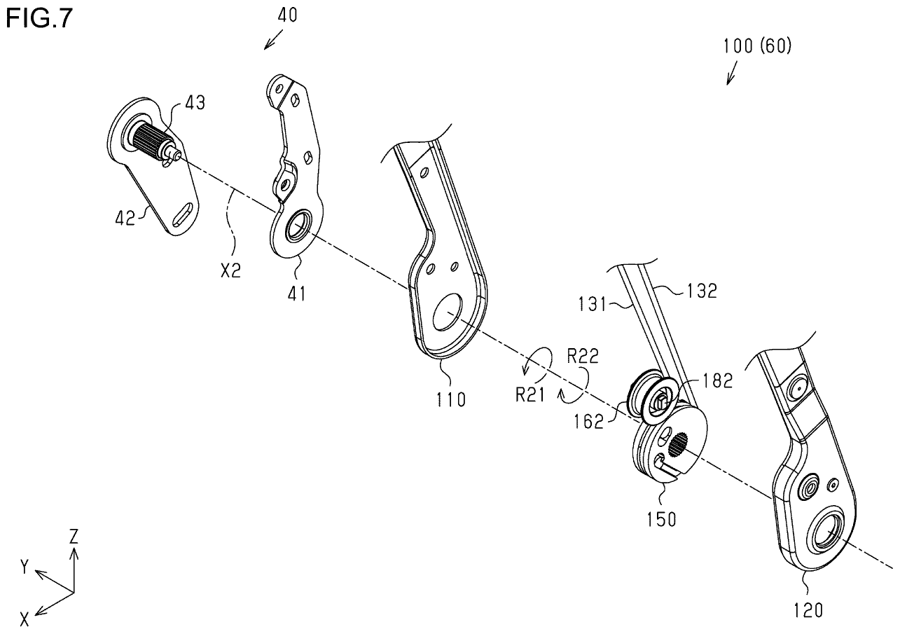

As illustrated in FIGS. 5 and 6, a base end portion of the base 110 is fixed to the door-side bracket 52 of the first hinge 50 via the link support shaft 183. As illustrated in FIG. 7, a tip end portion of the base 110 is fixed to the upper bracket 41 of the second hinge 40 via the second coupling shaft 43. In this respect, the base 110 is fixed to the upper door 31.

As illustrated in FIGS. 5, 6, and 8, the first pulley 140 is supported by the door-side bracket 52 of the first hinge 50 via the link support shaft 183. In this respect, an axis of the link support shaft 183, which is the rotation axis of the first pulley 140, is shifted from the first door axis X1 that is the rotation axis of the upper door 31. The first pulley 140 is rotatable about the axis of the link support shaft 183. The first intermediate pulley 161 is supported by the door-side bracket 52 via the pulley support shaft 181. The first intermediate pulley 161 is rotatable about an axis of the pulley support shaft 181. In the door-side bracket 52, a position where the pulley support shaft 181 passes through is close to a position where the link support shaft 183 passes through. As a result, the first intermediate pulley 161 is disposed near the first pulley 140. The first rotation direction R31 and the second rotation direction R32 of the first pulley 140 are rotation directions around the axis of the link support shaft 183.

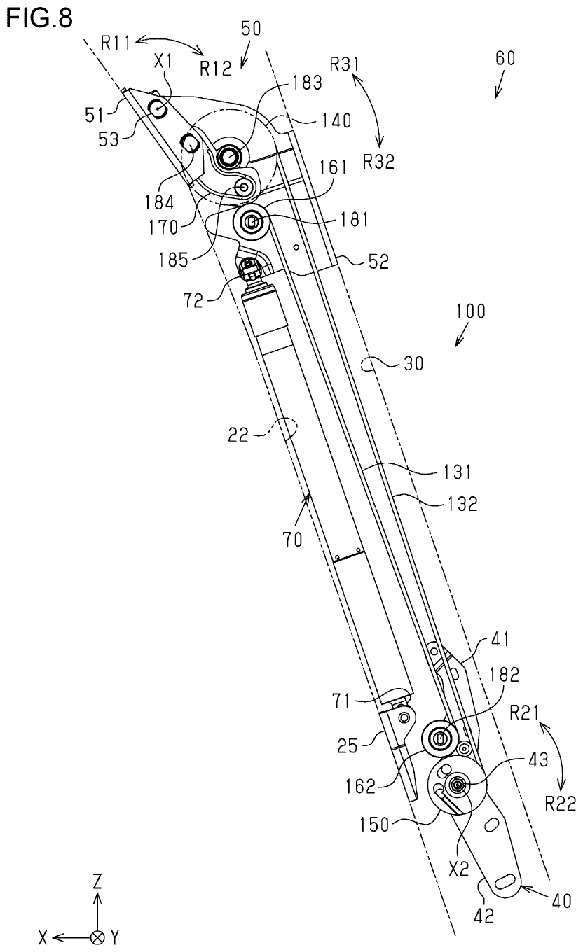

As illustrated in FIGS. 7 and 8, the second pulley 150 is integrated with the lower bracket 42 via the second coupling shaft 43. Specifically, a portion of the second coupling shaft 43 passing through the base 110 is inserted into the second pulley 150. At this time, a portion having a non-circular cross section of the second coupling shaft 43 is inserted into a non-circular hole of the second pulley 150. In this way, the second pulley 150 is not rotatable with respect to the second coupling shaft 43. In other words, the second pulley 150 is rotatable integrally with the second coupling shaft 43. In the embodiment, as viewed from an axial direction of the second coupling shaft 43, a boundary between the second pulley 150 and the second coupling shaft 43 has a serrated shape. In this way, the second pulley 150 rotates together with the second coupling shaft 43 and the lower bracket 42 of the second hinge 40. The second intermediate pulley 162 is supported by the upper bracket 41 via the pulley support shaft 182. The second intermediate pulley 162 is rotatable about an axis of the pulley support shaft 182. In the upper bracket 41, a position where the pulley support shaft 182 passes through is close to a position where the second coupling shaft 43 passes through. As a result, the second intermediate pulley 162 is disposed near the second pulley 150.

As illustrated in FIGS. 5, 6, and 8, a base end portion of the transmission link 170 is supported by the vehicle body-side bracket 51 via the link support shaft 184. The base end portion of the transmission link 170 is rotatable about an axis of the link support shaft 184 with respect to the vehicle body-side bracket 51. On the other hand, a tip end portion of the transmission link 170 is coupled to the coupling portion 142b of the first pulley 140 via the link support shaft 185. The transmission link 170 and the first pulley 140 are relatively rotatable about an axis of the link support shaft 185. In this respect, the transmission link 170 couples the vehicle body 20 and the first pulley 140.

As illustrated in FIGS. 5 to 7, the opening cable 131 is wound around the first intermediate pulley 161 and the second intermediate pulley 162 in addition to the first pulley 140 and the second pulley 150. On the other hand, the closing cable 132 is wound only around the first pulley 140 and the second pulley 150. As illustrated in FIG. 8, since the opening cable 131 is wound around the first intermediate pulley 161 and the second intermediate pulley 162, a routing path of the opening cable 131 is close to a routing path of the closing cable 132. The number and positions of the intermediate pulleys provided in the power transmission mechanism 100 can be appropriately changed as long as the routing path of the opening cable 131 can be brought closer to the routing path of the closing cable 132.

As illustrated in FIGS. 3 and 4, the cover 120 is fixed to the base 110 while covering the first pulley 140 and the second pulley 150, the first intermediate pulley 161 and the second intermediate pulley 162, and the opening cable 131 and the closing cable 132. In this way, components that operate among the components of the power transmission mechanism 100 are not exposed to the outside.

As illustrated in FIG. 8, the vehicle body-side bracket 51, the door-side bracket 52, the first pulley 140, and the transmission link 170 constitute a four-joint link mechanism. In the embodiment, four inter-axis distances, which are lengths of the four links constituting the four-joint link mechanism, have the following relationship. Among the four inter-axis distances, the longest inter-axis distance is the inter-axis distance between the first coupling shaft 53 and the link support shaft 183, and the shortest inter-axis distance is the inter-axis distance between the link support shaft 183 and the link support shaft 185. Of the remaining two inter-axis distances, the inter-axis distance between the link support shaft 184 and the link support shaft 185 is longer than the inter-axis distance between the first coupling shaft 53 and the link support shaft 184. Therefore, when the vehicle body-side bracket 51 rotates about the first door axis X1 in accordance with opening and closing operations of the upper door 31, the first pulley 140 rotates about the axis of the link support shaft 183 while moving in the front-rear direction and the up-down direction, describing a circular arc.

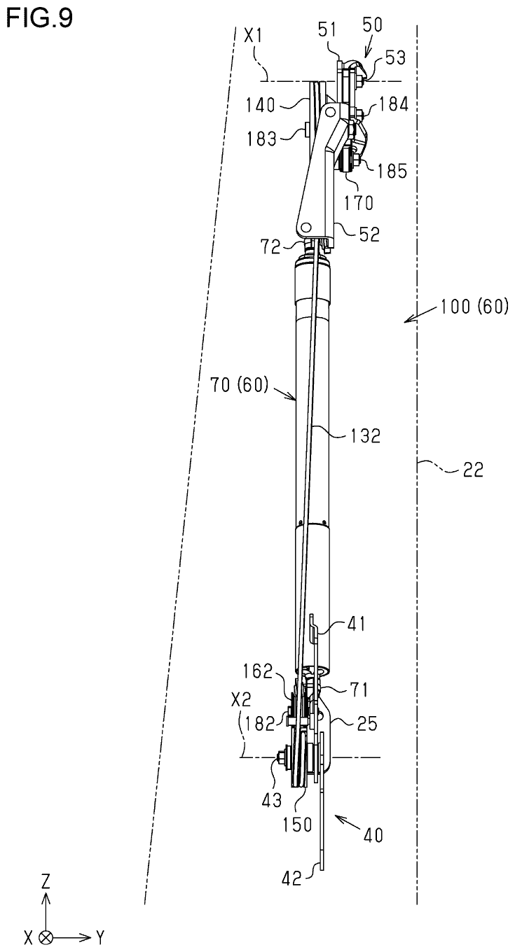

As illustrated in FIG. 9, as viewed from the rear of the vehicle 10, the rear pillar 22 extends outward in the width direction while extending downward. When the back door 30 is located at the fully closed position, the door drive unit 70 and the power transmission mechanism 100 are disposed along the rear pillar 22. Specifically, the door drive unit 70 and the power transmission mechanism 100 are disposed in a space corresponding to a width of the rear pillar 22 in the width direction and a gap between the rear pillar 22 and the back door 30 in the front-rear direction.

The first pulley 140 and the first intermediate pulley 161 are located inward of the second pulley 150 and the second intermediate pulley 162 in the width direction. That is, when the back door 30 is located at the fully closed position, a portion of the opening cable 131 between the first intermediate pulley 161 and the second intermediate pulley 162 extends outward in the width direction while extending downward. Similarly, a portion of the closing cable 132 between the first pulley 140 and the second pulley 150 extends outward in the width direction while extending downward. Further, portions of the opening cable 131 and the closing cable 132 between the first intermediate pulley 161 and the second intermediate pulley 162 overlap the door drive unit 70. In other words, the greater parts of the opening cable 131 and the closing cable 132 are aligned with the door drive unit 70 in the front-rear direction, but are not aligned with the door drive unit 70 in the width direction.

The door-side bracket 52 and the transmission link 170 are both rotatably supported by the vehicle body-side bracket 51. Therefore, a position of the door-side bracket 52 in the width direction is substantially the same as a position of the transmission link 170 in the width direction. Therefore, as illustrated in FIG. 9, when the vehicle 10 is viewed from the rear side, the greater part of the transmission link 170 is hidden by the door-side bracket 52.

### Door Control Device 200

The door control device 200 is a processing circuit including a CPU and a memory. The door control device 200 controls the door lock drive unit 34 and the door drive unit 70 based on an operation request for the back door 30.

The operation request for the back door 30 is generated when a driver operates a switch of a portable device, the driver operates a switch provided around the driver's seat, or a user of the vehicle 10 operates the back door 30 or a switch provided around the back door 30.

When an opening operation request for the back door 30 is generated, the door control device 200 controls the door lock drive unit 34 to displace the latch 33a of the door lock mechanism 33. Specifically, by displacing the latch 33a of the door lock mechanism 33 to the unlatch position, the restraint of the back door 30 to the vehicle body 20 is released. Subsequently, the door control device 200 controls the door lock drive unit 34 to open the back door 30 to the fully open position. On the other hand, when a closing operation request for the back door 30 is generated, the door control device 200 controls the door drive unit 70 to close the back door 30. When the back door 30 is closed to the vicinity of the fully closed position, the door control device 200 controls the door lock drive unit 34 to displace the latch 33a of the door lock mechanism 33. Specifically, the back door 30 is restrained to the vehicle body 20 by displacing the latch 33a of the door lock mechanism 33 to the full-latch position.

### Operations of Embodiment

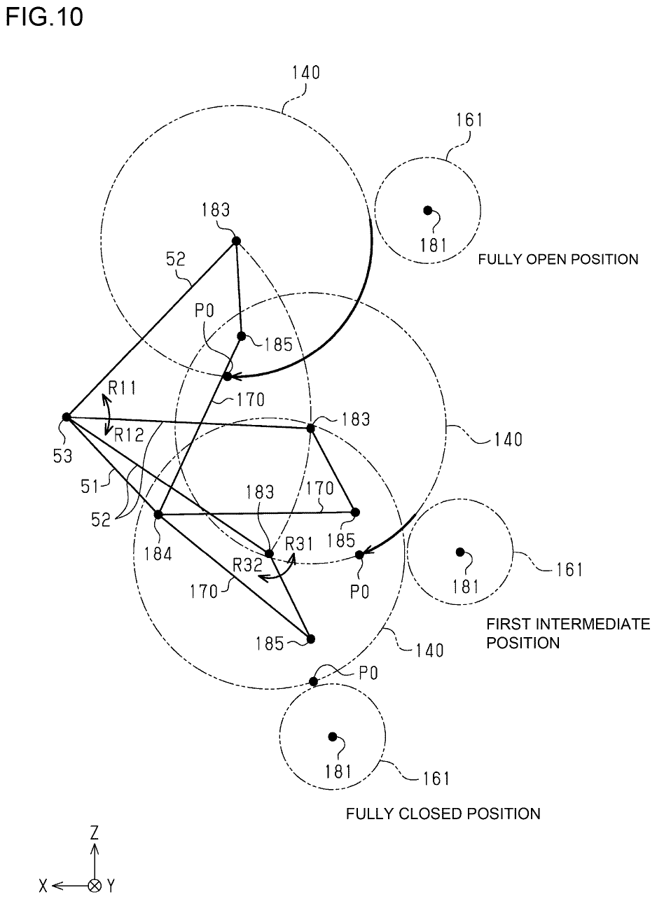

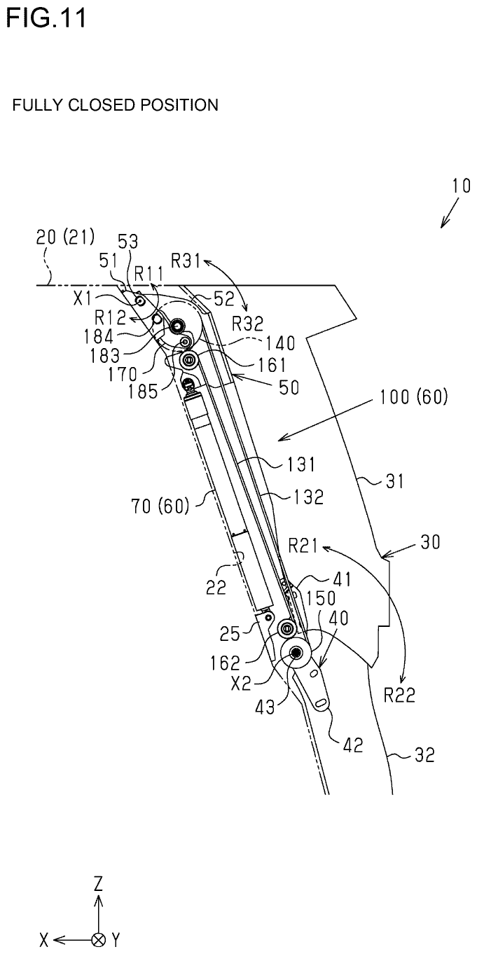

Operations at the time of an opening operation of the back door 30 will be described with reference to FIGS. 10 to 15. FIG. 10 is a diagram schematically illustrating a part of the components of the power transmission mechanism 100 corresponding to FIGS. 11, 12, and 14. In FIG. 10, an initial position P0 is a point set on an outer shape of the first pulley 140, and a solid arrow toward the initial position P0 indicates a movement amount of the initial position P0 accompanying the opening operation of the back door 30, that is, a rotation amount of the first pulley 140.

As illustrated in FIGS. 10 and 11, when the back door 30 is located at the fully closed position, the upper door 31 is rotated most in the second rotation direction R12 with respect to the vehicle body 20, and the lower door 32 is rotated most in the first rotation direction R21 with respect to the upper door 31. The first pulley 140 is rotated most in the first rotation direction R31, and the second pulley 150 is rotated most in the first rotation direction R31. That is, the first pulley 140 most winds up the closing cable 132, and the second pulley 150 most unwinds the closing cable 132. Further, the rotation axis of the first pulley 140 is located at the lowermost position in a movement range associated with opening and closing operations of the back door 30. Therefore, the first pulley 140 is located below the roof 21 of the vehicle body 20. Further, the weather strip 26 and the two stoppers 27 are elastically compressed by contact with the back door 30.

When the back door 30 is opened from the fully closed position, first, the restraint of the back door 30 to the vehicle body 20 is released by the door lock drive unit 34. Subsequently, when the door drive unit 70 extends, the upper door 31 rotates in the first rotation direction R11 with respect to the vehicle body 20. When the upper door 31 rotates in the first rotation direction R11 with respect to the vehicle body 20, the door-side bracket 52 also rotates in the first rotation direction R11. Then, the first pulley 140 is operated by the action of the four-joint link mechanism including the vehicle body-side bracket 51, the door-side bracket 52, the first pulley 140, and the transmission link 170. Specifically, as illustrated in FIGS. 10 and 12, the first pulley 140 rotates in the second rotation direction R32 while rotating in the first rotation direction R11 together with the door-side bracket 52. In other words, the first pulley 140 performs two rotational motions having different positions of the rotation axis. Subsequently, when the first pulley 140 winds up the opening cable 131, the second pulley 150 rotates in the second rotation direction R22. As a result, the lower door 32 rotates in the second rotation direction R22 with respect to the upper door 31. In other words, the back door 30 is folded. The position of the back door 30 illustrated in FIG. 12 is a first intermediate position where a door opening degree is larger than that at the fully closed position.

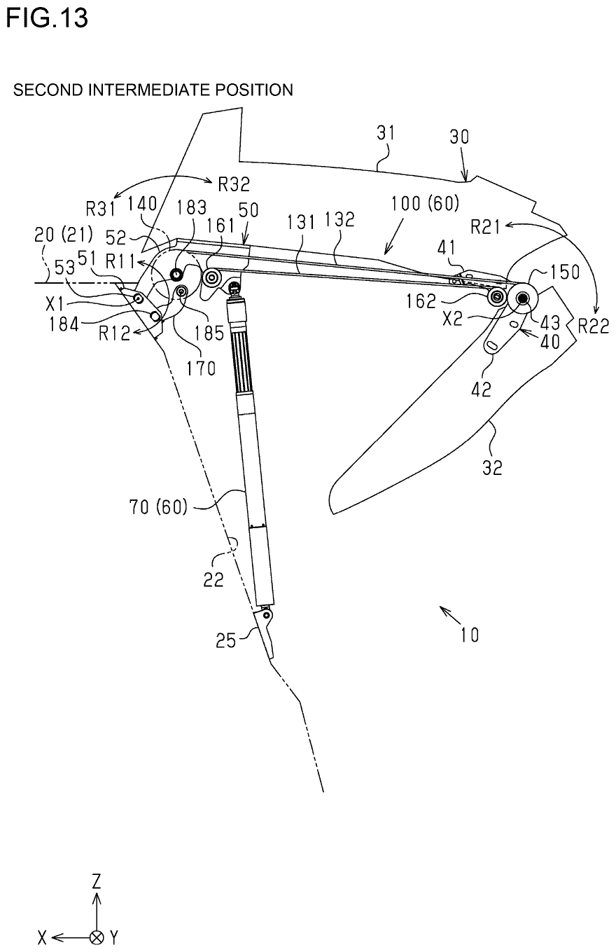

As illustrated in FIG. 13, as the door drive unit 70 extends, a rotation amount of the upper door 31 in the first rotation direction R11 increases, and a rotation amount of the lower door 32 with respect to the first rotation direction R21 increases. Here, the reason why a rotation amount increment of the lower door 32 is larger than a rotation amount increment of the upper door 31 is that the outer diameter of the first pulley 140 is larger than the outer diameter of the second pulley 150. The position of the back door 30 illustrated in FIG. 13 is a second intermediate position where the door opening degree is larger than that at the first intermediate position.

As illustrated in FIGS. 10, 14, and 15, when the door drive unit 70 is fully extended, the opening operation of the back door 30 is completed. That is, the back door 30 is disposed at the fully open position. When the back door 30 is located at the fully open position, the upper door 31 is rotated most in the first rotation direction R11 with respect to the vehicle body 20, and the lower door 32 is rotated most in the second rotation direction R22 with respect to the upper door 31. The first pulley 140 is rotated most in the second rotation direction R32, and the second pulley 150 is rotated most in the second rotation direction R32. That is, the first pulley 140 most winds up the opening cable 131, and the second pulley 150 most unwinds the opening cable 131. Therefore, the back door 30 is folded most. Further, the rotation axis of the first pulley 140 is located at the uppermost position in the movement range associated with the opening and closing operations of the back door 30. As a result, the first pulley 140 is located above the roof 21 of the vehicle body 20. Comparing the case where the back door 30 is located at the fully closed position with the case where the back door 30 is located at the fully open position, the lower door 32 is rotated by about 180 degrees with respect to the upper door 31. In this respect, when the back door 30 is located at the fully open position, the upper door 31 and the lower door 32 overlap in the up-down direction.

Operations at the time of the closing operation of the back door 30 will be briefly described.

As illustrated in FIGS. 10 to 14, when the back door 30 performs the closing operation from the fully open position, the door drive unit 70 contracts. Then, the upper door 31 and the door-side bracket 52 rotate in the second rotation direction R12 with respect to the vehicle body 20. Therefore, the first pulley 140 rotates in the first rotation direction R31 while rotating in the second rotation direction R12 together with the door-side bracket 52. That is, when the first pulley 140 winds up the closing cable 132, the second pulley 150 rotates in the first rotation direction R21. As a result, the lower door 32 rotates in the first rotation direction R21 with respect to the upper door 31. In other words, the folded state of the back door 30 is released. In the case where the back door 30 performs the closing operation, a rotation amount decrement of the lower door 32 is larger than a rotation amount decrement of the upper door 31 as in the case where the back door 30 performs the opening operation. As illustrated in FIGS. 10 and 11, when the door drive unit 70 is fully contracted, the closing operation of the back door 30 is completed. That is, the back door 30 is disposed at the fully closed position. Thereafter, the back door 30 is restrained to the vehicle body 20 by the door lock drive unit 34.

### Effects of Embodiment

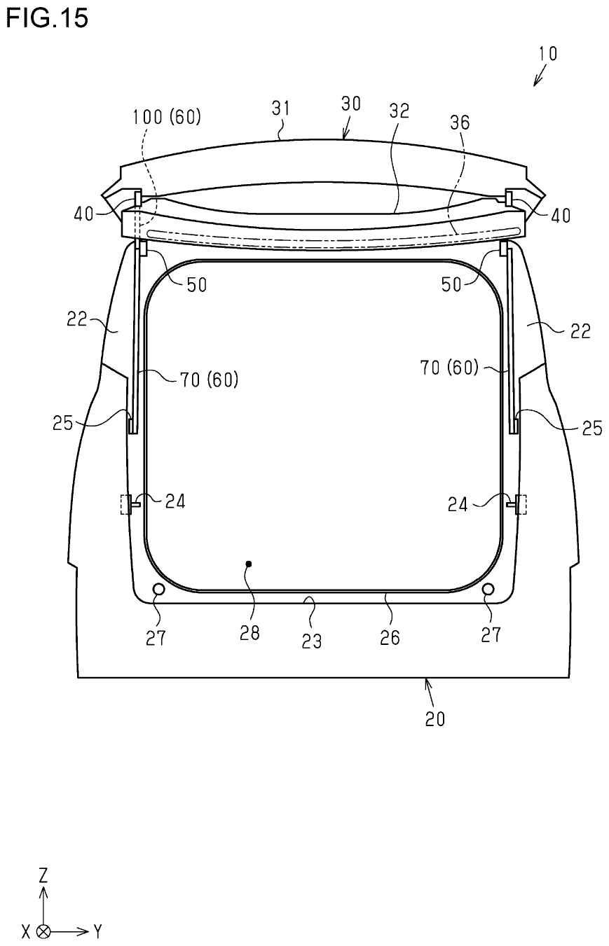

(1) The door opening and closing device 60 can convert a rotational motion of the upper door 31 with respect to the vehicle body 20 into a rotational motion of the lower door 32 with respect to the upper door 31 by the power transmission mechanism 100 including the first pulley 140, the second pulley 150, the opening cable 131, and the closing cable 132. Therefore, the door opening and closing device 60 can drive both the upper door 31 and the lower door 32 only by driving the upper door 31. Therefore, the door opening and closing device 60 does not need to include both a drive unit for driving the upper door 31 and a drive unit for driving the lower door 32. In this way, in the door opening and closing device 60, a structure for opening and closing the foldable back door 30 can be simplified.
(2) As illustrated in FIG. 8, in the door opening and closing device 60, the outer diameter of the first pulley 140 is larger than the outer diameter of the second pulley 150. Therefore, in the door opening and closing device 60, the rotation amount of the lower door 32 with respect to the upper door 31 can be made larger than the rotation amount of the upper door 31 with respect to the vehicle body 20 at the time of the opening and closing operations of the back door 30. In the embodiment, at the time of the opening operation of the back door 30, even when the rotation amount of the upper door 31 is less than 90 degrees, the lower door 32 rotates to such an extent that the tip end of the lower door 32 is close to the base end of the upper door 31. Therefore, as illustrated in FIG. 15, the door opening and closing device 60 can prevent the door opening 28 from being hidden by the lower door 32 when the back door 30 is disposed at the fully open position.
(3) The door opening and closing device 60 can transmit motive power from the upper door 31 to the lower door 32 via the first pulley 140, the second pulley 150, the opening cable 131, and the closing cable 132. Therefore, in the door opening and closing device 60, the weight of the device can be reduced as compared with a case where a sprocket and a chain are used instead of the pulley and the cable, or a belt is used instead of the cable.
(4) The upper door 31 is configured to rotate with respect to the vehicle body 20, whereas the lower door 32 is configured to further rotate with respect to the upper door 31. In this respect, the door opening and closing device 60 includes the door drive unit 70 that applies a torque to the upper door 31 that moves more simply than the lower door 32 during the opening and closing operations of the back door 30. Therefore, in the door opening and closing device 60, the degree of freedom in arrangement of the door drive unit 70, the degree of freedom in selection of the door drive unit 70, and the like can be increased.
(5) When the first door axis X1, which is the rotation axis of the upper door 31, and the rotation axis of the first pulley 140 coincide with each other, the arrangement, size, and the like of the first pulley 140 are likely to be restricted since the first pulley 140 needs to be disposed on the first door axis X1. For example, when the first pulley 140 is disposed on the first door axis X1, the roof 21 needs to be curved upward in order to avoid interference with the first pulley 140. Further, since the outer diameter of the first pulley 140 is smaller, the outer diameter of the first pulley 140 may become smaller than the outer diameter of the second pulley 150. In contrast, in the door opening and closing device 60, the first pulley 140 can be disposed at a position away from the first door axis X1 by the transmission link 170. Therefore, in the door opening and closing device 60, the occurrence of restrictions on the arrangement, size, and the like of the first pulley 140 can be reduced.
(6) In the vehicle 10, the first pulley 140, the transmission link 170, the vehicle body-side bracket 51, and the door-side bracket 52 constitute a four-joint link mechanism. In this respect, in the door opening and closing device 60, the rotation axis of the first pulley 140 can be shifted from the first door axis X1 by a simple mechanism.

Further, in the door opening and closing device 60, the rotation amount of the first pulley 140 accompanying the opening and closing operations of the back door 30 can be increased by the action of the four-joint link mechanism. Specifically, as illustrated in FIG. 10, when the back door 30 is opened from the fully closed position to the fully open position, the rotation amount of the first pulley 140 in the second rotation direction R32 is larger than a rotation amount of the door-side bracket 52 in the first rotation direction R11. Therefore, even when the outer diameter of the first pulley 140 is reduced, a rotation amount of the second pulley 150 accompanying the opening and closing operations of the back door 30 can be secured in the door opening and closing device 60. That is, an increase in the size of the device can be restricted in the door opening and closing device 60.
(7) In the door opening and closing device 60, the first pulley 140 and the second pulley 150 are disposed so as to be shifted from each other in a direction in which rotation axes thereof extend, the rotation axes thereof being parallel to each other. Therefore, the door opening and closing device 60 can be disposed along the silhouette of the vehicle 10. Specifically, the door opening and closing device 60 can be disposed along the rear pillar 22 that extends outward in the width direction while extending downward as viewed from the rear.
(8) The power transmission mechanism 100 can stably transmit motive power even when a driving-side rotating body and a driven-side rotating body are arranged so as to be shifted from each other in the width direction since the motive power is transmitted by a pulley and a cable. Specifically, the power transmission mechanism 100 can stably transmit the motive power even when the first pulley 140 and the first intermediate pulley 161, which are driving-side rotating bodies, and the second pulley 150 and the second intermediate pulley 162, which are driven-side rotating bodies, are arranged so as to be shifted in the width direction. In other words, in the power transmission mechanism 100, the first pulley 140 and the first intermediate pulley 161, which are driving-side rotating bodies, and the second pulley 150 and the second intermediate pulley 162, which are driven-side rotating bodies, are allowed to be arranged so as to be shifted in the width direction.
(9) In the door opening and closing device 60, the routing paths of the opening cable 131 and the closing cable 132 between the first pulley 140 and the second pulley 150 can be changed by the first intermediate pulley 161 and the second intermediate pulley 162. Therefore, in the door opening and closing device 60, a space for arranging other components can be secured by changing the routing paths of the opening cable 131 and the closing cable 132 by the first intermediate pulley 161 and the second intermediate pulley 162. Specifically, as illustrated in FIG. 8, the routing path of the opening cable 131 is close to the closing cable 132 by the first intermediate pulley 161 and the second intermediate pulley 162. Therefore, in a side view when the back door 30 is located at the fully closed position, there is a space for disposing the door drive unit 70 between the rear pillar 22 of the vehicle body 20 and the opening cable 131. In other words, even when the gap between the rear pillar 22 and the back door 30 located at the fully closed position is small, the power transmission mechanism 100 can be accommodated in the gap.
(10) As illustrated in FIG. 2, in a state where the back door 30 is located at the fully closed position, the back door 30 is restrained to the vehicle body 20 via the two door lock mechanisms 33. However, since the door lock mechanism 33 does not restrain the back door 30 to the vehicle body 20 so as to restrict any displacement of the back door 30, the lower door 32 may slightly rotate in the second rotation direction R22 around the second door axis X2 with respect to the upper door 31. In this respect, the vehicle 10 includes the weather strip 26 and the two stoppers 27 as components for restricting the rotation of the lower door 32 in the second rotation direction R22. Therefore, in the vehicle 10, the relative rotation of the upper door 31 and the lower door 32 around the second door axis X2 at the back door 30 located at the fully closed position can be restricted. As a result, for example, the occurrence of vibration or unusual sounds at the rear portion of the vehicle 10 during traveling can be restricted in the vehicle 10.

### Modifications

The embodiment may be modified as follows. The embodiment and the following modifications can be implemented in combination with each other within a technically consistent range.

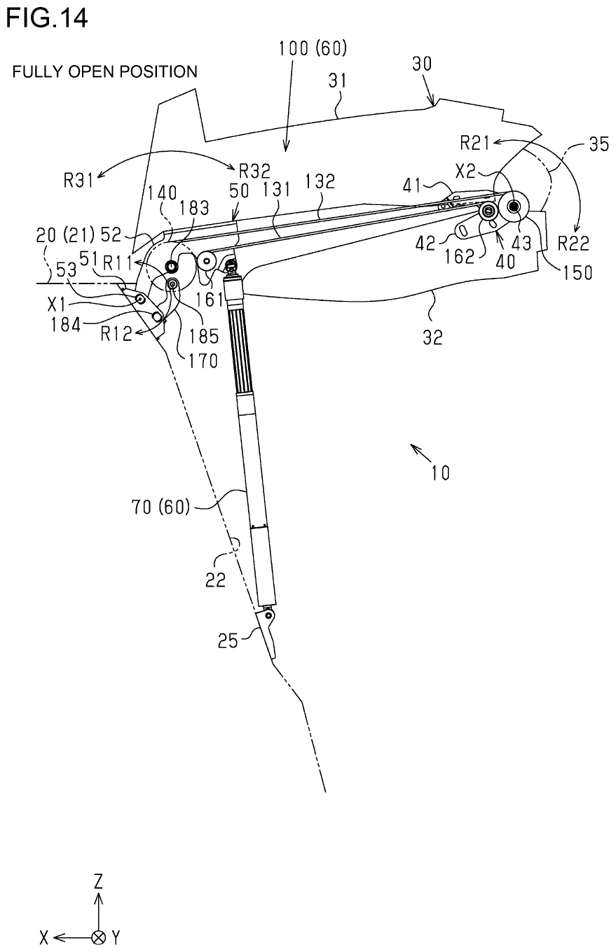

When the back door 30 is located at the fully open position, a gap is formed between the lower end of the upper door 31 and the upper end of the lower door 32. Therefore, it is preferable that a liquid such as rainwater and other objects do not get in between the upper door 31 and the lower door 32 via the gap. Therefore, as indicated by a two-dot chain line in FIG. 14, the back door 30 may include a door cover 35 that closes the gap. The door cover 35 is preferably made of a material having appropriate elasticity and water resistance. The door cover 35 preferably seals the gap between the lower end of the upper door 31 and the upper end of the lower door 32 across the width direction. Alternatively, the back door 30 may include an eaves extending from the lower end of the upper door 31.

When the back door 30 is located at the fully closed position and a gap is formed between the lower end of the upper door 31 and the upper end of the lower door 32, a liquid such as rainwater may enter the vehicle interior while the vehicle 10 is parked or traveling. Therefore, as indicated by a two-dot chain line in FIG. 15, the back door 30 preferably includes a seal 36 that closes a gap between a tip end portion of the upper door 31 and a base end portion of the lower door 32. Similarly to the weather strip 26, the seal 36 is preferably elastically compressed between the tip end portion of the upper door 31 and the base end portion of the lower door 32 when the back door 30 is located at the fully closed position.

The door drive unit 70 may not be a linear motion actuator. For example, the door drive unit 70 may be an actuator that drives the upper door 31 using a plurality of links.

The door drive unit 70 may be a gas spring that applies a torque in the opening direction to the upper door 31. In this case, the back door 30 is opened and closed by a manual operation of the user.

The door drive unit 70 may be configured to apply a torque around the second door axis X2 to the lower door 32. In this case, when the door drive unit 70 drives the lower door 32, a torque is transmitted from the second pulley 150 to the first pulley 140. Subsequently, the upper door 31 rotates about the first door axis X1 based on the torque transmitted to the first pulley 140.

The power transmission mechanism 100 may include a speed increasing mechanism that transmits motive power from the second pulley 150 to the lower door 32 in a state where a rotational speed of the second pulley 150 is increased. The power transmission mechanism 100 may include a speed reducing mechanism that transmits motive power from the second pulley 150 to the lower door 32 in a state where the rotational speed of the second pulley 150 is reduced.

The power transmission mechanism 100 may not include the closing cable 132 as long as the opening cable 131 is provided. In this case, at the time of the closing operation of the back door 30, the lower door 32 rotates in the first rotation direction R21 by a torque corresponding to the weight of the lower door 32 acting around the second door axis X2. The second pulley 150 winds up the opening cable 131 in response to the rotation of the lower door 32 in the first rotation direction R21.

The power transmission mechanism 100 may include two sprockets instead of the first pulley 140 and the second pulley 150, and may include a chain wound around the two sprockets instead of the opening cable 131 and the closing cable 132. The power transmission mechanism 100 may include a belt instead of the opening cable 131 and the closing cable 132.

In the power transmission mechanism 100, the outer diameter of the first pulley 140 may be equal to or smaller than the outer diameter of the second pulley 150.

In the power transmission mechanism 100, the rotation axis of the first pulley 140 may coincide with the first door axis X1, which is the rotation axis of the upper door 31. In this case, the first pulley 140 is preferably coupled to the upper door 31 so as to be rotatable integrally with the upper door 31.

In the power transmission mechanism 100, the first pulley 140 may be disposed at the same position as the second pulley 150 in the width direction. That is, when the power transmission mechanism 100 is viewed from the rear, the second pulley 150 may be located directly below the first pulley 140.

In the power transmission mechanism 100, the mechanism that converts a rotational motion of the door-side bracket 52 about the first door axis X1 into the rotational motion of the first pulley 140 may not be a four-joint link mechanism. For example, the power transmission mechanism 100 may include an input pulley that rotates integrally with the door-side bracket 52, an output pulley that rotates integrally with the first pulley 140, and a cable wound around the input pulley and the output pulley. In this modification, the rotational motion of the door-side bracket 52 can be transmitted to the first pulley 140 via the input pulley, the output pulley, and the cable that correspond to the “transmission body”. The power transmission mechanism 100 may include an input gear that rotates integrally with the door-side bracket 52, and an output gear that meshes with the input gear and rotates integrally with the first pulley 140. In this modification, the rotational motion of the door-side bracket 52 can be transmitted to the first pulley 140 via the input gear and the output gear that correspond to the “transmission body”.

The back door 30 may be configured such that the first door axis X1 and the second door axis X2 extend in the up-down direction like a folding door of a bus. In other words, the vehicle 10 according to the modification may be configured such that the back door 30, the two first hinges 50, and the door opening and closing device 60 in the vehicle 10 according to the above embodiment are rotated by 90 degrees about an axis extending in the front-rear direction.

The “vehicle door” may be a side door that opens and closes a door opening that opens in a side surface of the vehicle body 20. In this case, the side door may be configured such that the first door axis X1 and the second door axis X2 extend in the front-rear direction, or may be configured such that the first door axis X1 and the second door axis X2 extend in the up-down direction.

In the above embodiment, the vehicle 10 includes a plurality of rotary members extending around an axis extending in the width direction. Here, the rotation axes of the plurality of rotary members may be slightly inclined with respect to the width direction as long as the plurality of rotary members can rotate without difficulty.

### Summary of Embodiments

A door opening and closing device is a door opening and closing device for opening and closing a vehicle door that opens and closes a door opening of a vehicle body, the vehicle door including a first door that rotates about a first door axis with respect to the vehicle body and a second door that rotates about a second door axis extending in the same direction as the first door axis with respect to the first door, the door opening and closing device including: a first rotating body configured to rotate together with the first door; a second rotating body configured to rotate together with the second door; and a transmission member wound around both the first rotating body and the second rotating body, and configured to transmit a torque from one rotating body of the first rotating body and the second rotating body to the other rotating body by being unwound from the other rotating body of the first rotating body and the second rotating body when being wound up around the one rotating body.

The door opening and closing device can convert one of a rotational motion of the first door with respect to the vehicle body and a rotational motion of the second door with respect to the first door into the other by the first rotating body, the second rotating body, and the transmission member. Therefore, the door opening and closing device can drive both the first door and the second door only by driving one of the first rotating body and the second rotating body, that is, one of the first door and the second door. In this way, in the door opening and closing device, a structure for opening and closing a back door including the first door and the second door can be simplified.

In the door opening and closing device, it is preferable that an outer diameter of the first rotating body is larger than an outer diameter of the second rotating body.

In the door opening and closing device, a rotation change amount of the second door with respect to the first door can be made larger than a rotation change amount of the first door with respect to the vehicle body.

In the door opening and closing device, it is preferable that the first rotating body is a first pulley, the second rotating body is a second pulley, the transmission member includes an opening cable having both end portions fixed to the first pulley and the second pulley, respectively, and a closing cable having both end portions fixed to the first pulley and the second pulley, respectively, the first pulley winds up the opening cable and the second pulley winds up the closing cable when the first door operates in an opening direction, and the first pulley winds up the closing cable and the second pulley winds up the opening cable when the first door operates in a closing direction.

The door opening and closing device can transmit motive power from one of the first door and the second door to the other via the first pulley, the second pulley, the opening cable, and the closing cable. Since the door opening and closing device uses two cables as the transmission member, for example, the weight of the device can be reduced as compared with a case where a belt or a chain is used as the transmission member.

It is preferable that the door opening and closing device further includes a door drive unit configured to apply, to the first door, a torque for operating the first door in an opening direction.

The door opening and closing device includes a door drive unit that applies a torque to the first door that moves more simply than the second door during opening and closing operations of the vehicle door. In this respect, in the door opening and closing device, the degree of freedom in arrangement of the door drive unit, the degree of freedom in selection of the door drive unit, and the like can be increased.

It is preferable that the door opening and closing device further includes a transmission body configured to couple the vehicle body and the first rotating body and rotate the first rotating body in response to rotation of the first door, and a rotation axis of the first rotating body is shifted from the first door axis.

When the first door axis, which is a rotation axis of the first door, and the rotation axis of the first rotating body coincide with each other, the arrangement, size, and the like of the first rotating body are likely to be restricted since the first rotating body needs to be disposed on the first door axis. In contrast, in the door opening and closing device having the above configuration, the first rotating body can be disposed at a position away from the first door axis by the transmission body. Therefore, in the door opening and closing device, the occurrence of restrictions on the arrangement, size, and the like of the first rotating body can be restricted.

It is preferable that the vehicle door rotates about the first door axis with respect to the vehicle body via a door hinge including a vehicle body-side bracket fixed to the vehicle body and a door-side bracket fixed to the vehicle door, the first rotating body is rotatably supported by the door-side bracket, the transmission body is a transmission link having one end portion relatively rotatably coupled to the vehicle body-side bracket and the other end portion relatively rotatably coupled to the first rotating body, and the first rotating body, the transmission link, the vehicle body-side bracket, and the door-side bracket constitute a four-joint link mechanism.

In the door opening and closing device, a mechanism that rotates the first rotating body in response to the rotation of the first door can be implemented with a simple configuration.

In the door opening and closing device, it is preferable that the first rotating body is a first pulley, the second rotating body is a second pulley, the transmission member is a cable, the rotation axis of the first rotating body and a rotation axis of the second rotating body extend in parallel, and the first rotating body is disposed so as to be shifted from the second rotating body in a direction in which the rotation axes of the first rotating body and the second rotating body extend.

In the door opening and closing device, the first rotating body and the second rotating body are disposed so as to be shifted from each other in the direction in which the rotation axes extend, the rotation axes thereof being parallel to each other. Therefore, the door opening and closing device can be disposed, for example, along the silhouette of the vehicle and the door opening.

It is preferable that the door opening and closing device further includes an intermediate rotating body that is disposed between the first rotating body and the second rotating body and around which the transmission member is wound.

In the door opening and closing device, a routing path of the transmission member between the first rotating body and the second rotating body can be changed by the intermediate rotating body. For example, in the door opening and closing device, a space for disposing other members can be secured by changing a routing path of the transmission member by the intermediate rotating body.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A door opening and closing device for opening and closing a vehicle door that opens and closes a door opening of a vehicle body, the vehicle door including a first door that rotates about a first door axis with respect to the vehicle body and a second door that rotates about a second door axis extending in a same direction as the first door axis with respect to the first door, the door opening and closing device comprising:
a first rotating body configured to rotate together with the first door;
a second rotating body configured to rotate together with the second door; and
a transmission member wound around both the first rotating body and the second rotating body, and configured to transmit a torque from one rotating body of the first rotating body and the second rotating body to the other rotating body by being unwound from the other rotating body of the first rotating body and the second rotating body when being wound up around the one rotating body.

2. The door opening and closing device according to claim 1, wherein
an outer diameter of the first rotating body is larger than an outer diameter of the second rotating body.

3. The door opening and closing device according to claim 1, wherein
the first rotating body is a first pulley,
the second rotating body is a second pulley,
the transmission member includes an opening cable having both end portions fixed to the first pulley and the second pulley, respectively, and a closing cable having both end portions fixed to the first pulley and the second pulley, respectively,
the first pulley winds up the opening cable and the second pulley winds up the closing cable when the first door operates in an opening direction, and
the first pulley winds up the closing cable and the second pulley winds up the opening cable when the first door operates in a closing direction.

4. The door opening and closing device according to claim 2, wherein
the first rotating body is a first pulley,
the second rotating body is a second pulley,
the transmission member includes an opening cable having both end portions fixed to the first pulley and the second pulley, respectively, and a closing cable having both end portions fixed to the first pulley and the second pulley, respectively,
the first pulley winds up the opening cable and the second pulley winds up the closing cable when the first door operates in an opening direction, and
the first pulley winds up the closing cable and the second pulley winds up the opening cable when the first door operates in a closing direction.

5. The door opening and closing device according to claim 1, further comprising:
a door drive unit configured to apply, to the first door, a torque for operating the first door in an opening direction, wherein
the first rotating body, the transmission member, and the second rotating body are driven by the door drive unit when the first door rotates in the opening direction.

6. The door opening and closing device according to claim 2, further comprising:
a door drive unit configured to apply, to the first door, a torque for operating the first door in an opening direction, wherein
the first rotating body, the transmission member, and the second rotating body are driven by the door drive unit when the first door rotates in the opening direction.

7. The door opening and closing device according to claim 1, wherein
an end portion of the second door rotatably coupled to the first door is a base end portion of the second door as viewed in a direction in which the second door axis extends, and
the second rotating body is fixed to the base end portion of the second door.

8. The door opening and closing device according to claim 2, wherein
an end portion of the second door rotatably coupled to the first door is a base end portion of the second door as viewed in a direction in which the second door axis extends, and
the second rotating body is fixed to the base end portion of the second door.

9. The door opening and closing device according to claim 1, further comprising:
a cover covering the first rotating body, the second rotating body, and the transmission member.

10. The door opening and closing device according to claim 2, further comprising:
a cover covering the first rotating body, the second rotating body, and the transmission member.
